(19) United States
(12) Patent Application Publication
(10) Pub. No.: US 2016/0036632 A1
(43) Pub. Date: Feb. 4, 2016

(54) COMPUTER SYSTEM

(71) Applicant: HITACHI, LTD., Tokyo (JP)

(72) Inventors: Keiko Tanigawa, Tokyo (JP); Toshio Otani, Tokyo (JP); Toru Tanaka, Tokyo (JP)

(21) Appl. No.: 14/423,475

(22) PCT Filed: Oct. 3, 2013
(86) PCT No.: PCT/JP2013/076995

§ 371 Date: Feb. 24, 2015

(51) Int. Cl. H04L 12/24

(52) U.S. Cl. CPC H04L 41/0803; H04L 41/0893

(57) ABSTRACT

In a computer system connected to a client, the client has a system configuration including a first storage that stores data and a first computer, the computer system has a second storage that stores data and a second computer that processes data stored in the second storage and a management server, the management server acquires an identifier of an application processed in the first computer, data utilized for executing the application and stored in the first storage and information of the system configuration of the client from the client, the system configuration is composed in the second storage and the second computer based upon the acquired information of the system configuration, the application specified by the identifier is operated in the composed system configuration using the acquired data, and a result of the operation is output to the client.

### TECHNICAL FIELD

The present invention relates to a computer system.

### BACKGROUND ART

When an IT system is constructed, the configuration of hardware and the scale of the system are generally estimated in designing the system and a budget is secured. System engineers and others who have the know-how of system construction estimate the scale based upon performance requirements, the specifications of the hardware and results of utilizing benchmark tools and sizing tools.

However, as a period from a few months to a few years is required between the system design and the initiation of the service, estimate data at the time of the system design is not necessarily a suitable value in real operation. When conditions required for the system are not met, it is conceivable that an additional budget and others due to the addition of short resources and a replacement for high throughput of hardware are required, the availability of resources is low and cost effectiveness is low when a higher estimate is made in anticipation of the increase of workloads.

Concerning technique for determining the size of a unit, PTL1 for example discloses technique of a sizing device of a computer system for determining the size of each unit in a computer system for a test so that balance in performance among each unit calculated by performance balance evaluation means is in a predetermined range, acquiring a sizing factor for fitting the size of a reference unit in the computer system for a test to size required for a corresponding unit in the design object computer system and determining the size of each unit that configures the design object computer system by multiplying the size of each unit in the computer system the balance in performance of which is corrected by the sizing factor.

In addition, in NPL1, a service level in consideration of a characteristic of a work load of an application is set, hardware is classified according to the service level, and the classification of the hardware is reported in a catalog. For example, for parallel processing such as High Performance Computing (HPC) and service in which low latency is regarded as important, hardware having high throughput is selected and for the backup and the archive of a file, low-cost hardware that can process big data but low throughput is selected. A user can specify hardware by selecting the hardware according to such classification from the catalog and can purchase it.

### CITATION LIST

### Patent Literature

PTL 1: Japanese Patent No. 4526774

### Non Patent Literature

NPL 1: http://www.emc.com/collateral/software/white-papers/h11471-opt-cloud-virt-apps-vmax-cloud-edition-wp.pdf

### SUMMARY OF INVENTION

### Technical Problem

According to the technique disclosed in PTL1, the size of each unit can be determined. However, when real environment of the existing system is utilized for a test, an effect upon the performance of the existing system by executing a test application is concerned. Further, since real environment of an existing system is not inherited in a pure computer system for a test, system performance in real operation in which the real environment is inherited may be different.

In addition, according to the technique disclosed in NPL1, the hardware can be specified and can be purchased, but it is difficult to set the service level. Even if a benchmark tool and a sizing tool are used for setting the service level, these tools are simulators and may be different from system performance in real operation.

Further, since the sizing of an conventional IT system has been done by mere calculation in system design in which a budget is appropriated in terms of financial management, the sizing has an old supposed value especially in a large scale system in which a period till the initiation of service is long, and the possibility that resizing is required when the service is initiated is considered. During the operation of service, it is considered that many scenes where resizing is required such as the increase of workloads, the addition of an application, the upgrade of service and hardware resources and replacement occur. Since the real system exists in the operation of service, sizing in the real system is possible. However, it is difficult to ordinarily secure environment for resizing.

Then, the present invention has it for its object to provide a method of performing the sizing of hardware in an application system that meets a performance requirement and supporting the selection of a system configuration according to the performance requirement of the application system in a life cycle of the application service from the installation to the disposal.

### Solution to Problem

A computer system according to the present invention is based upon a computer system connected to a client, and has a characteristic that the client has a system configuration provided with a first storage unit that stores data and a first computer, the computer system has a second storage unit that stores data, a second computer that processes data stored in the second storage and a management server, the management server acquires an identifier of an application processed in the first computer, data utilized for executing the application and stored in the first storage unit and the information of the system configuration of the client from the client, the management server composes the system configuration in the second storage unit and the second computer based upon the information of the acquired system configuration, the management server operates the application specified in the identifier by the composed system configuration using the acquired data, and the management server outputs a result of the operation to the client.

Further, the present invention also provides a processing method in the computer system.

### Advantageous Effects of Invention

According to the present invention, since the evaluation is that of real workloads by the real system, a high precision test result can be provided. Further, since resources for resizing are not required in plenty of resizing in the operation of service, the concentration of resources on the proper business of a user can be supported.

### BRIEF DESCRIPTION OF DRAWINGS

FIG. 1 shows an outline of a sizing service system;

FIG. 2 shows an example of the configuration of a computer system;

FIG. 3 shows an example of the configuration of a sizing server;

FIG. 4 shows an example of the configuration of a server and a storage;

FIG. 5 shows an example of the configuration of a sizing client;

FIG. 6 shows an example of a request table;

FIG. 7 shows an example of DC resource management;

FIG. 8 shows an example of a DC schedule;

FIG. 9 shows an example of test patterns;

FIG. 10 shows an example of a service list;

FIG. 11 shows an example of a report list;

FIG. 12 shows an example of a case list;

FIG. 13 shows an example of an H/W cost list;

FIGS. 14A and 14B show an example of a script;

FIG. 15 shows an example of a process flow of the sizing server;

FIG. 16 shows an example of a process flow of the acceptance of a sizing request;

FIG. 17 shows an example of a process flow of the calculation of a configuration;

FIG. 18 shows an example of a process flow of the generation of a test report;

FIG. 19 shows an example of a process flow of a sizing client;

FIG. 20 shows an example of a virtual disc management table;

FIG. 21 shows an example of server performance information;

FIG. 22 shows an example of a client screen showing the input of a sizing request;

FIG. 23 shows an example of a client screen showing the output of a sizing report; and

FIG. 24 shows an example of log information.

### DESCRIPTION OF EMBODIMENT

This embodiment produces the operational environment of an application system for a user in a computer system of a data center (DC), performs a performance test of the application system, outputs data related to a system configuration plan that meets a performance requirement, and provides support in selecting the configuration of hardware.

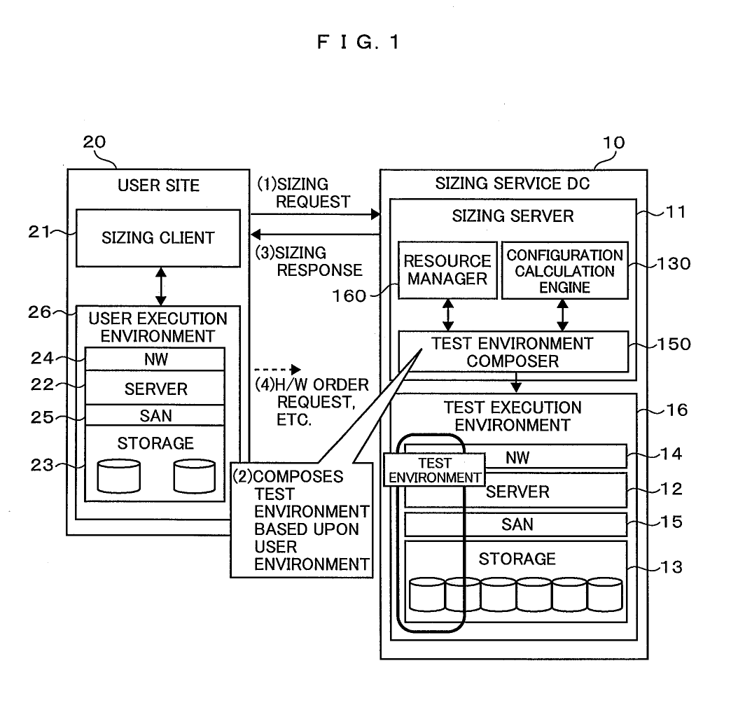

FIG. 1 shows an example of the outline of a sizing service system in this embodiment. This sizing service is executed according to a sizing request and a response to it between sizing service DC 10 (hereinafter called DC 10) that provides sizing service and a user site 20 that requests sizing service. The DC 10 is configured by a sizing server 11 that manages the acceptance of a request for sizing service, the deployment of object service, a test and reporting and test execution environment 16 including a server 12, a storage 13, a network (NW) 14 between servers and a storage area network (SAN) 15 which is a network between server and storages. A user site 20 is configured by a sizing client (hereinafter called a client) 21 that exchanges information related to sizing with the sizing server and execution environment 26 of a user including a server 22, a storage 23, NW 24 between servers and SAN 25. In the sizing server 11 that receives a sizing request (1) from the client 21, a configuration calculation engine 130 calculates a test configuration (2) that executes the sizing request based upon information included in the sizing request (for example, an application name, a required condition, a package of environment (OS, software, data and others) in which an application is executed in the user execution environment 26 and the existing system configuration that executes the application), resource information and a resource used situation in the test execution environment 16, and composes the test configuration in real devices in the test execution environment 16, a test environment composer 150 composes test environment and executes a test. The sizing server 11 generates a report based upon a result of the test (3) and responds to the client 21.

Especially, as application execution environment of a user is reproduced by using a virtual disk image which is the environment of a virtual machine itself for a package of the environment when the virtual machine is included in the user execution environment 26 and using a physical memory image and a physical disk image for a package of the environment when no virtual machine is included and a test is performed in the real device in the DC 10, sizing data closer to user environment can be acquired. As a result, a hardware purchase plan just enough for a required condition for the installation and the enhancement of a system can be made, and a cost for installation can be reduced. For example, for a hardware maker, since it is facilitated to concretely explain merits when hardware manufactured by another maker is replaced by installing the DC 10 and providing sizing data including hardware manufactured by the maker itself and an exact system configuration for new installation and expansion can be also proposed, reliability is acquired and it contributes to lasting business.

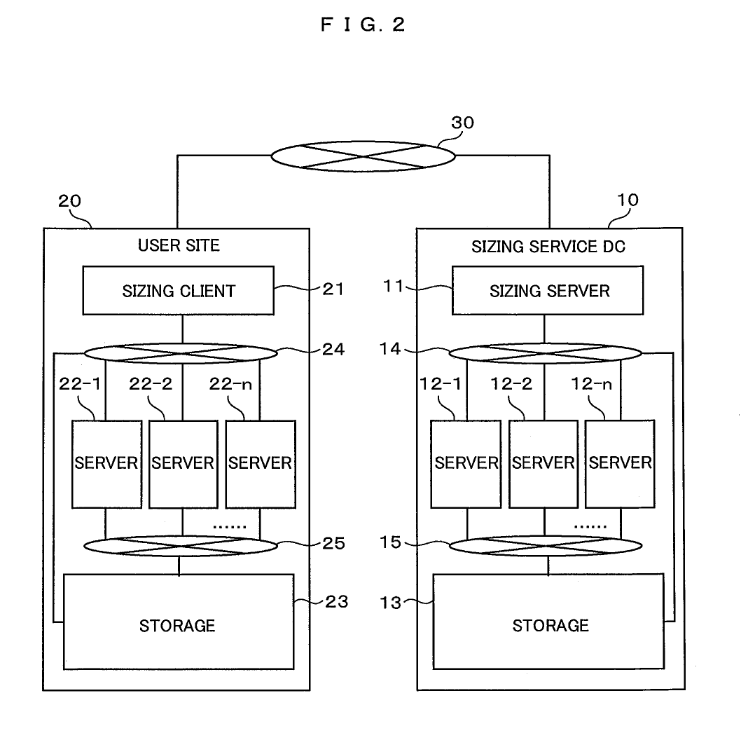

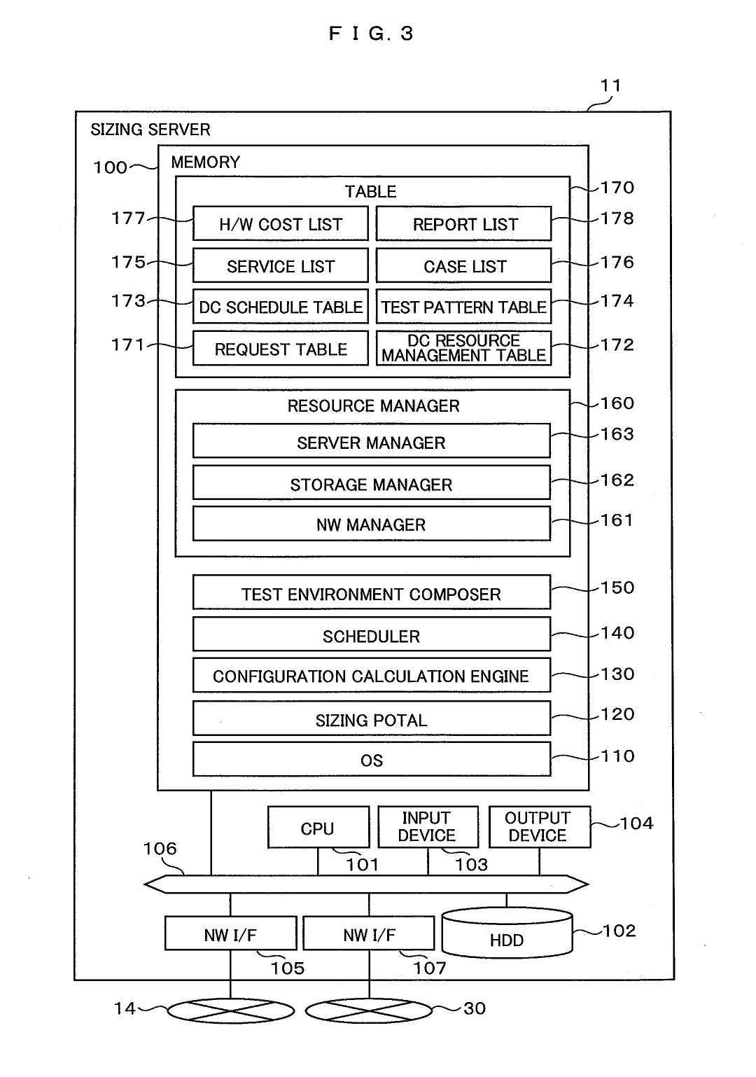

FIG. 2 shows an example of the physical connection of the computer system in this embodiment. As shown in FIG. 2, the DC 10 and the user site 20 are connected via a NW 30, the server 12 is configured by plural servers 12-1 to 12-n, and the respective servers are connected to the NW 14 and SAN 15. The configuration of the server 22 is also the same as that of the server 12. The same reference numeral is allocated to the same part as that in FIG. 1. The internal configuration of each part shown in FIG. 2 will be described using FIGS. 3 to 5 below.

FIG. 3 shows an example of the internal configuration of the sizing server 11. The sizing server 11 includes a memory 100 which stores an operating system (hereinafter called OS) 110 that controls hardware and is a basic program for realizing information processing by programs further in higher order, a sizing portal 120 that provides an interface with the client 21, a configuration calculation engine 130 which is a program for calculating sizing test environment, a scheduler 140 that manages a schedule of plural sizing tests performed in the DC 10, a test environment composer 150 that composes sizing test environment according to the configuration calculation engine 130 and a resource manager 160 that manages resource in the DC 10, a CPU 101 that executes the above-mentioned programs 110 to 160 stored in the memory 100, an HDD 102, an input device 103 such as a keyboard and a mouse, an output device 104 such as a display, an NW interface (an LAN interface) 105 and an NW interface 107, and these are connected via a bus 106.

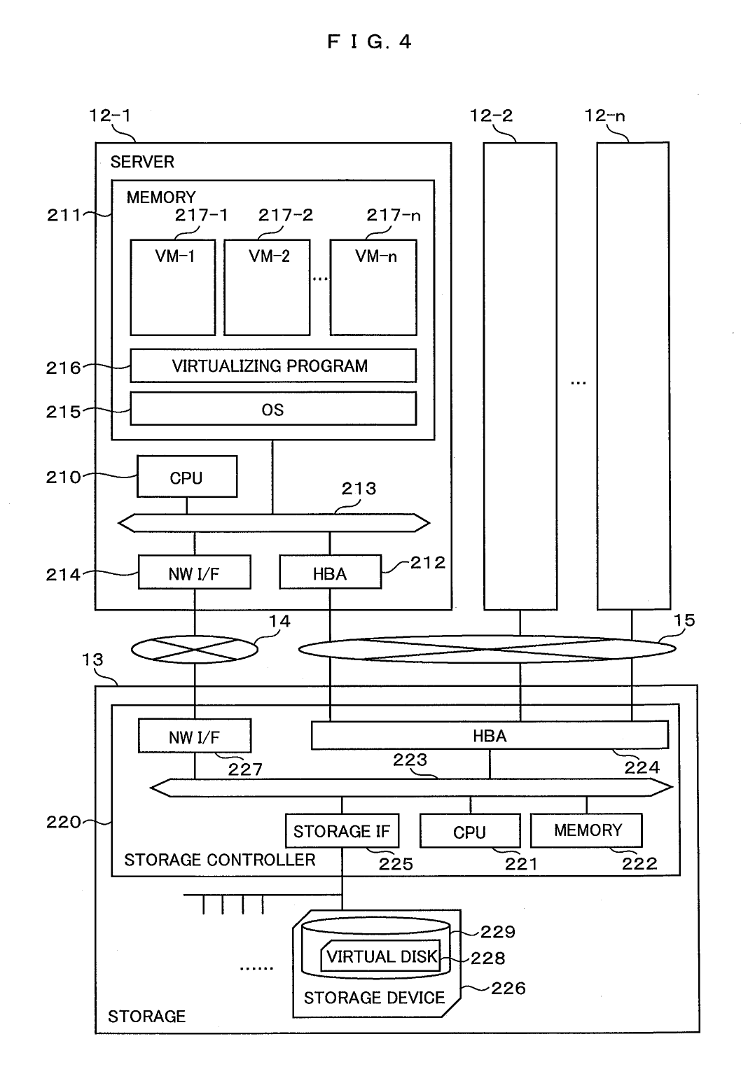

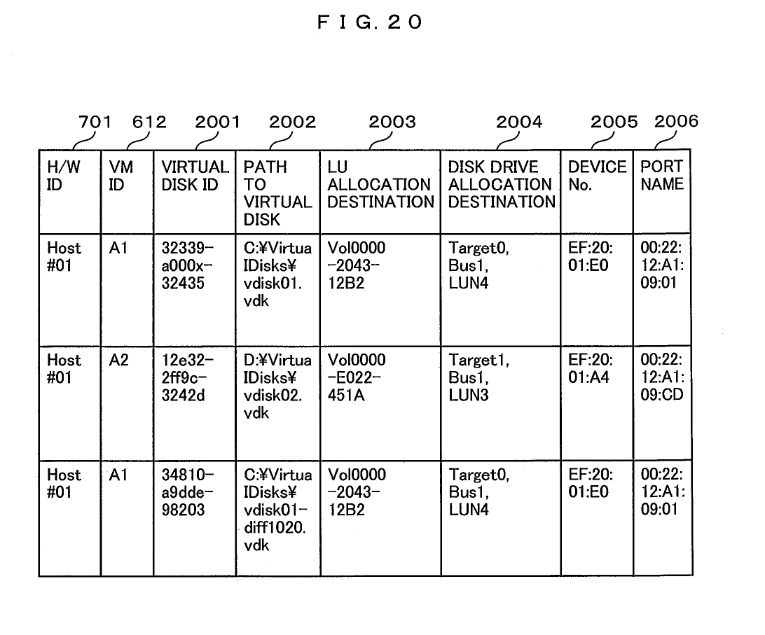

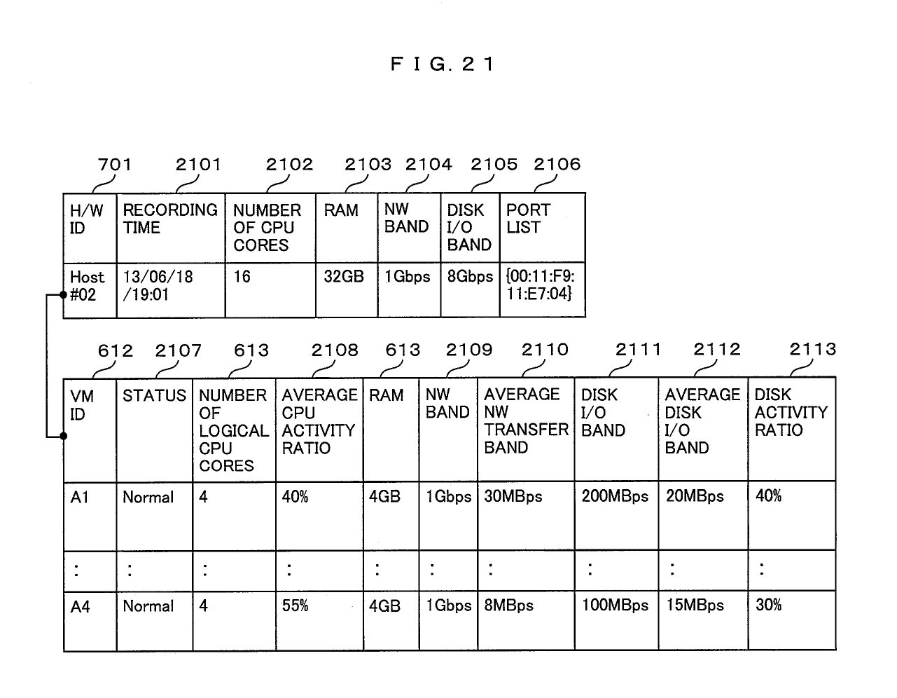

The resource manager 160 includes three programs of an NW manager 161, a storage manager 162 and a server manager 163. The server manager 163 manages the server 12 and a virtual server, that is, a virtual machine (hereinafter called VM) 217 when the VM 217 shown in FIG. 4 is activated in the server 12. For example, the server 12-1 acquires the configuration information and the performance information of the server 12 by communicating with a virtualizing program 216 or an OS 215 in the server 12-1 and changes the configuration of the server. Therefore, the server manager 163 manages a virtual disk management table described later using FIG. 20 and server performance information described later using FIG. 21. The virtual disk management table records the arrangement of virtual disks connected to the VM operated in the server 12 and the server performance information records the performance information of the server 12 and the VM.

The virtual disk is a type that a file or files is/are stored in a volume (recognized as a physical disk drive for the server) mounted in the server. The server recognizes the volume as a physical disk drive. In the virtual disk, a file which can be generated in fixed capacity and variable capacity is included.

When the virtual disk is configured according to a file format, the virtual disk management table may further also hold a so-called path showing a location in directory structure. The disk drive in the server is further divided into one or more logical volumes (or partitions) and a file system may be configured. Further, a connecting location of the disk drive is represented in the combination of LUN determined by the program that manages the OS and the VM and identification numbers of a target and a SCSI bus according to a standard of a small computer system interface (SCSI). A port name (WWN) used for connecting to a network such as the SAN 15 that connects the server 12 and the storage 13 is also managed.

The storage manager 162 manages the storage 13. For example, the storage manager 162 acquires the configuration information of the storage 13 by communicating with a storage controller 220 of the storage 13 and can change its configuration.

FIG. 4 shows an example of the system configuration of the server 12 and the storage 13 in the DC 10. The system configuration of the server 22 and the storage 23 in the user site 20 is also similar. The configuration of these may also be completely the same, the number of units included in the server 12 and the number of units included in the server 22 may also be different, and the server 22 may also be have a configuration provided with no VM. One or more servers 12-1, 12-2, - - - , 12-n and the storage 13 are connected via the SAN 15 configured by a fibre channel (hereinafter called FC) and an FC switch for example. Each server 12 is provided with a host bus adapter (HBA) 212 which is an adapter for housing the FC and is connected to HBA 224 of the storage 13 via each HBA 212. The SAN 15 that connects the server 12 and the storage 13 may also be a fibre channel over Ethernet (FCoE) using Ethernet (trademark).

The servers 12-1, - - - , 12-n respectively execute the OS 215, the virtualizing program 216 and one or more VMs 217-1, - - - , 217-n respectively stored in the memory 211 in a CPU 210.

The virtualizing program 216 realizes a function for logically dividing one hardware into one or more virtual areas. An application program is operated in the VM 217 in the virtual hardware area divided by the virtualizing program 216. To operate the application program, a suitable OS may also be operated inside the VM 217. In the terms of abstracting hardware, functions of the OS 215 and the virtualizing program 216 are similar and the virtualizing program 216 may also be mounted in the physical server as a part of the OS 215.

The application may also be operated in the VM 217 and may also be directly executed in the physical server 12. When the application is directly executed in the physical server 12, the virtualizing program 216 and the VM 217 are not required.

The storage 13 provides a storage area called a volume 229 that stores a virtual disk image 228 and configured every logical unit to equipment (for example, the server 12-1) connected to it. The storage 13 is provided with a storage controller 220 that collectively controls each component of a storage device 226 such as hard disk drive (HDD). When plural access paths to the storage controller 220 exist, for example, when a multi-path or a link aggregation is installed to enhance reliability and performance, plural ports are used.

The storage controller 220 receives and transmits data which processing by a program in the server 12 requires via Ethernet or the HBA 224 which is an interface of the FC for example. The storage controller 220 provides a storage area to the server according to the SCSI. The storage controller 220 is provided with a serial advanced technology attachment (SATA) for connecting to an HDD and a solid state drive (SSD) for example which are a physical storage device or serial attached SCSI (SAS) 225 and a network interface 227 for connecting to the sizing server 11 provided with the resource manager 160 and others.

In the storage controller 220, a process for generating and deleting a volume and changing the configuration for providing a storage area of the physical storage device with which the storage 13 is provided to the physical server as a volume is packaged. The configuration of each volume is managed in a volume definition table and the volume definition table includes items of a device identifier for uniquely identifying a volume in the device and the system, a volume type representing an attribute, a source device representing a relating volume when the corresponding volume is related to another volume, a host allocation flag showing whether connection to the physical server exists or not and a status showing the current condition of the volume and others.

As described above, each area of the physical storage device is managed as a volume. Access from the physical server to the volume is executed by specifying a number (a segment number) in the volume and data can be read and written by specifying a logical block addressing (LBA) area in a real physical disk drive and accessing to the area. The volume and (a network port of) the physical server are related via a logical access path.

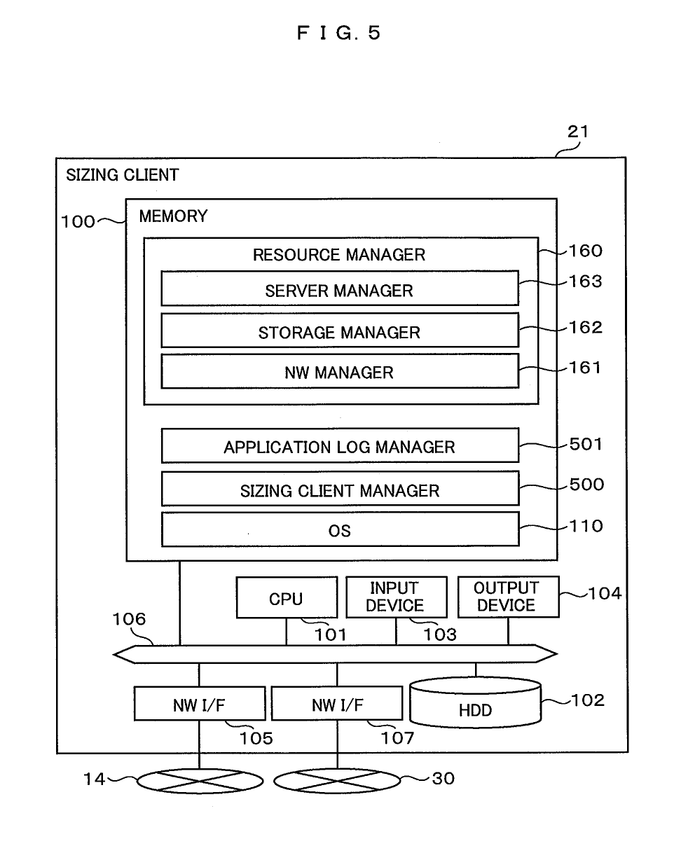

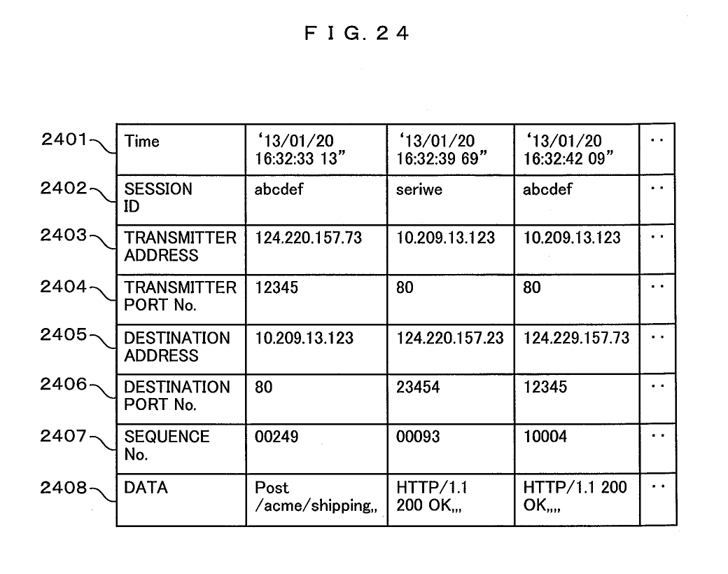

FIG. 5 shows an example of the internal configuration of the client 21. As shown in FIG. 5, since the same reference numeral is allocated to the same part as that in FIG. 3 and the configuration and the operation are the same, the description is omitted. However, a memory 100 includes a sizing client manager 500 which is connected to the sizing server 11, which makes a sizing request and which acquires performance information. Besides, the memory 100 includes an application log manager 501 and the application log manager collects and manages a log in which a user accessed to the system in the user site 20 and a log of an application operated in the server 22. Log information managed by the application log manager 501 will be described later using FIG. 24; the log information is used for reproducing the operation of the application in the server 12 in the DC 10. The resource manager 160 manages resources in the user site 20.

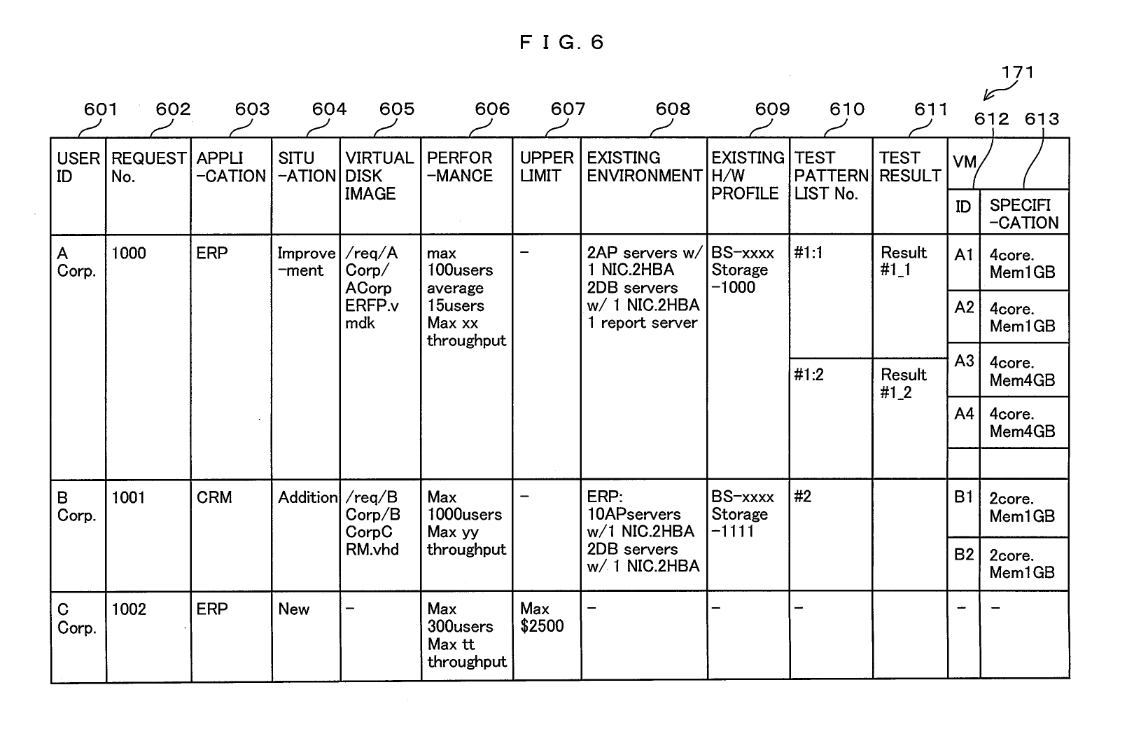

FIGS. 6 to 14 show examples of tables managed by the sizing server 11. FIG. 6 shows the request table 171 for managing application environment of a user, a condition required for performance and others respectively included in a sizing request accepted from the client 21.

The request table 171 holds ID 601 of the user that issues the sizing request, a request number 602 described later, an application name 603 of a sizing object, a situation 604 showing a trigger at which sizing is performed (for example, new installation, scale-out and scale-up according to the increase of workloads), a name 605 of a virtual disk image in which environment where the application of the sizing object is operated is packaged, a condition required for performance (for example, the maximum number of users who concurrently accessed: 300 persons and storage access performance: 100K input output per second (IOPS), performance 606 showing that latency is within 1 second, an upper limit 607 showing a constraint (for example, an upper limit of a hardware (H/W) cost) when sizing has the constraint, existing environment 608 showing environment where the current user site 20 is operated (for example, application servers: 2, DB servers: 2 and a reporting server: 1), an existing H/W profile 609 which is a profile (for example, a type of the server manufactured by X Corp.: xxxx and the storage manufactured by Y Corp.: yyyy) of hardware utilized in the current environment in which the user site 20 is operated, a test pattern list number 610 of a test pattern which the user wants to try, a test result 611 which is a result of a test specified according to the test pattern list number 610, the information of the VM when virtual environment is utilized in the active environment of the current user, for example, ID 612 of the VM and a specification 613 showing the number of logical cores and the capacity of a memory respectively allocated to the VM and others. Essential information when the test environment is composed in this table is the application name 603, the virtual disk image name 605, the performance 606, the existing environment 608 and the existing H/W profile 609.

Since it is considered that a difference is made in input information included in the sizing request depending upon a skill set such technical knowledge related to an IT system and IT service of a user, that is, all the items of the request table 171 cannot be entered because the knowledge is short, only an application is specified by the user and the rest may also be left to the side of the DC.

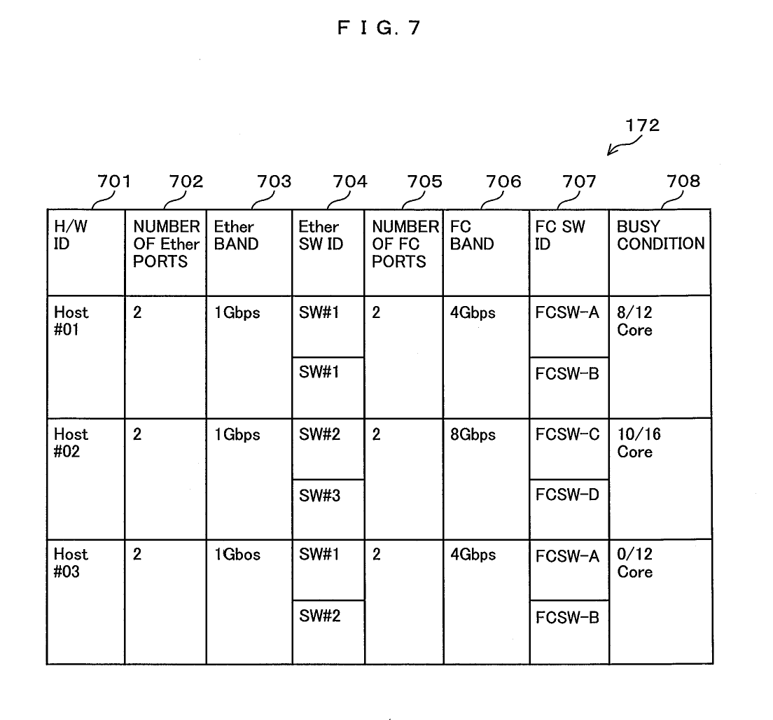

FIG. 7 shows an example of a DC resource management table 172 which is a management table of hardware resources in the test execution environment 16 in the DC 10. The DC resource management table is a table for managing H/W ID 701 for identifying hardware such as each server 12, an Ether port number 702 which is the number of ports of an NW interface 214 or the NW interface 227 for connecting to the NW 14, An Ethernet bandwidth 703 which is a bandwidth of Ethernet used for the communication of the NW 14, Ether SW ID 704 for identifying an Ethernet switch in the NW 14 to which the NW interface 214 or 227 is connected, an FC port number 705 of the HBA 212 or 224, an FC bandwidth 706 used for communication of the SAN 15, FC SW ID 707 for identifying an FC switch in the SAN 15 to which the HBA 212 or 224 is connected, a busy condition 708 (for example, Host No. 01 is using eight of twelve logical CPU cores) of hardware and others.

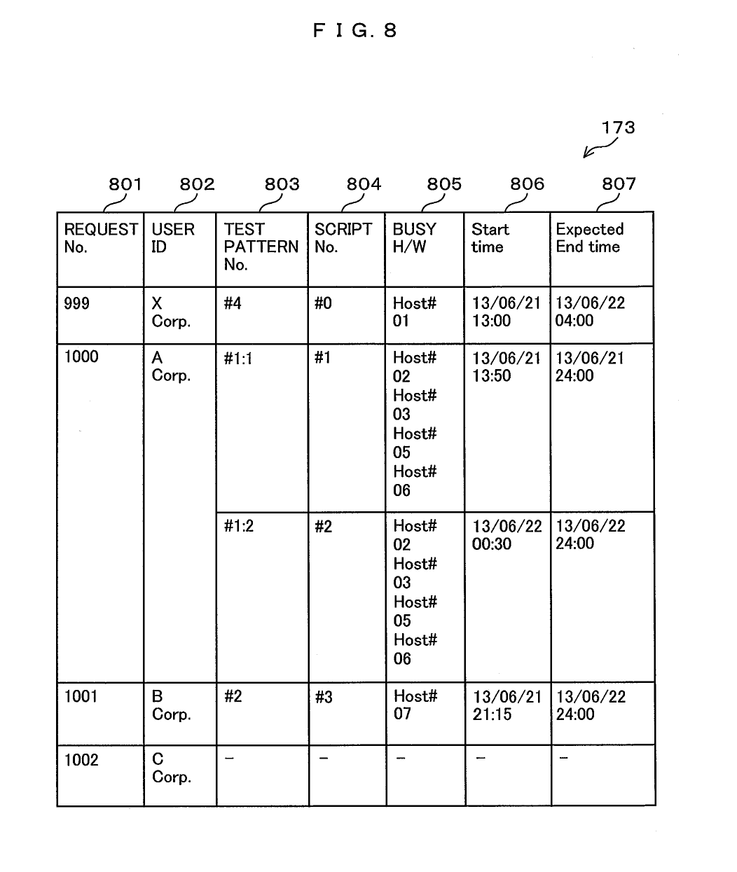

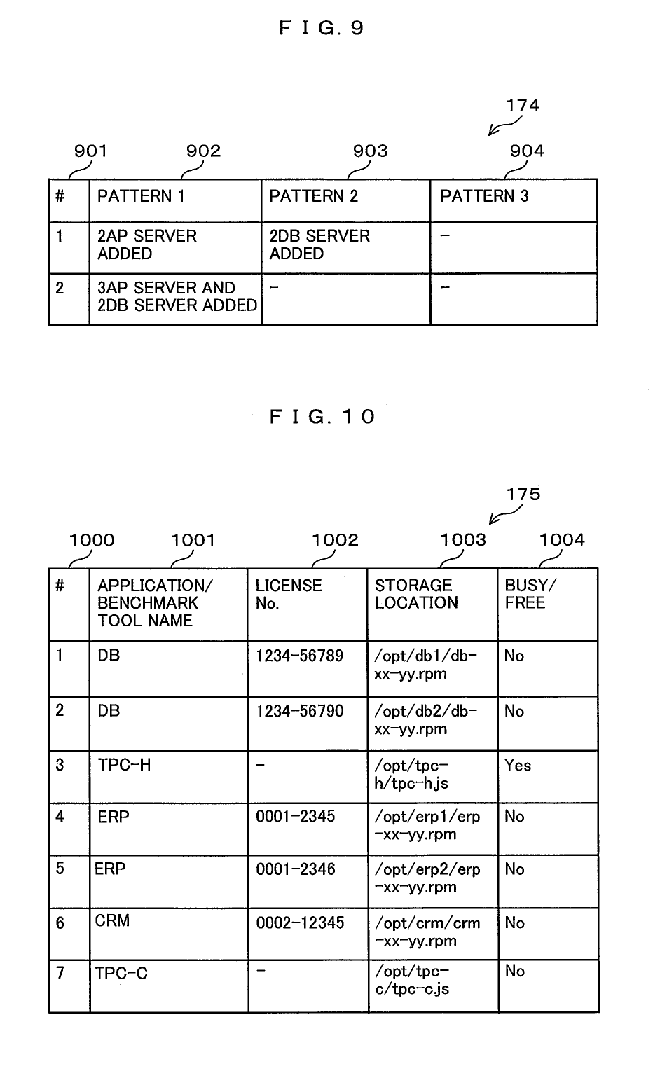

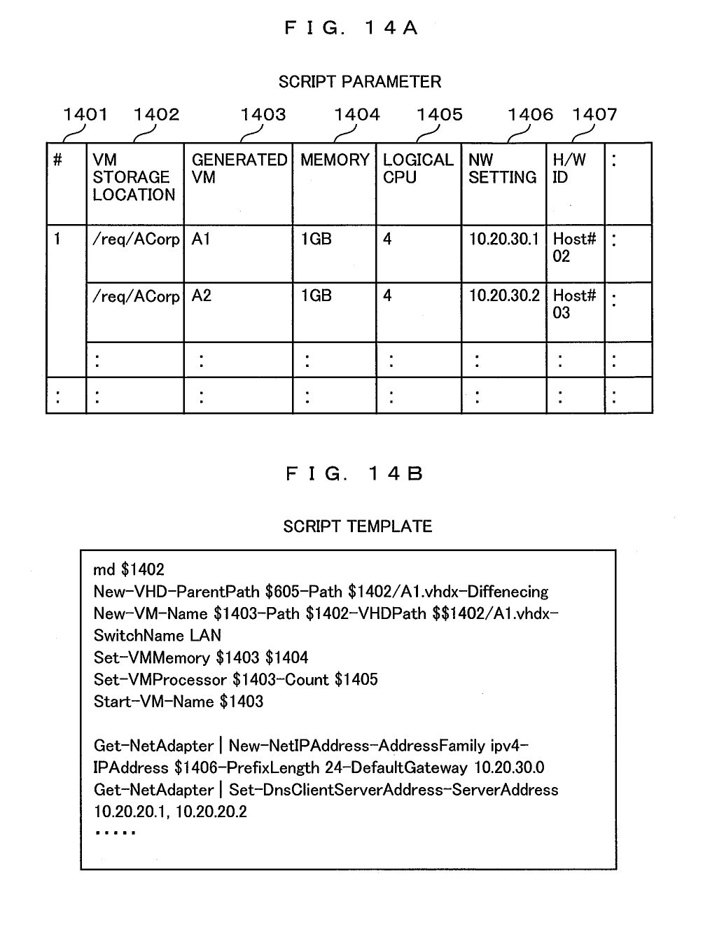

FIG. 8 shows an example of a DC schedule table 173 which is a management table for a schedule of tests performed in the DC 10. The DC schedule table is a table for managing a request number 801 corresponding to the request number 602 in the request table 171, user ID 802 corresponding to the user ID 601 for identifying a user who issues a request, a test pattern number 803 described using FIG. 9, a script number 804 described using FIGS. 14A and 14B and the like, busy H/W 805 which is information of hardware used for the test, start time 806 and expected end time 807 of the test and others.

FIG. 9 shows an example of a test pattern table 174 which is a management table of test patterns. The test pattern table 174 includes a test number 901, one or more test patterns 1 902 executed at the corresponding test number, a test pattern 2 903 and others. Therefore, for example, #1:2 in the test pattern number 803 shown in FIG. 8 shows the pattern 2 903 having the number of 1 in the test number 901. The contents of the test pattern table 174 are not limited to the addition of a server and may also be a change of the configuration of the program such as the addition of an application.

FIG. 10 shows a service list 175 which is a list of applications and benchmarks with which the DC 10 is provided and which are respectively available to a test. Since active environment of the user is copied in a test, the DC 10 is basically not required to hold an application included in the active environment of the user. However, some users want to perform sizing before the installation of a new application not included in the active environment of the users or it is meaningful that the DC 10 holds applications which include applications not included in active environment of users and benchmark tools for simulating the applications because the scale of the user site 20 to be evaluated is larger than that of the DC 10 and the whole system of the user site 20 cannot be migrated in the DC 10. The service list 175 is a list for managing an item 1000, an application/benchmark tool name 1001, a license number 1002 when a license is required for the application 1001, a location 1003 in which the application/benchmark tool is stored, busy/free 1004 showing whether the corresponding application/benchmark tool is already used for a certain test or not, and others.

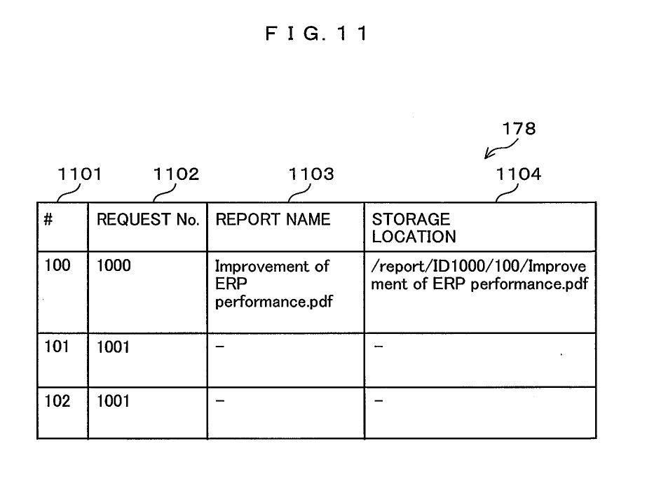

FIG. 11 shows an example of a report list 178 which is a management table for reports in which the sizing server 11 responds to the client 21. The report list includes an index number 1101, a request number 1102 corresponding to the request numbers 602, 801, a report name 1103, a location in which the report is stored 1104 and others.

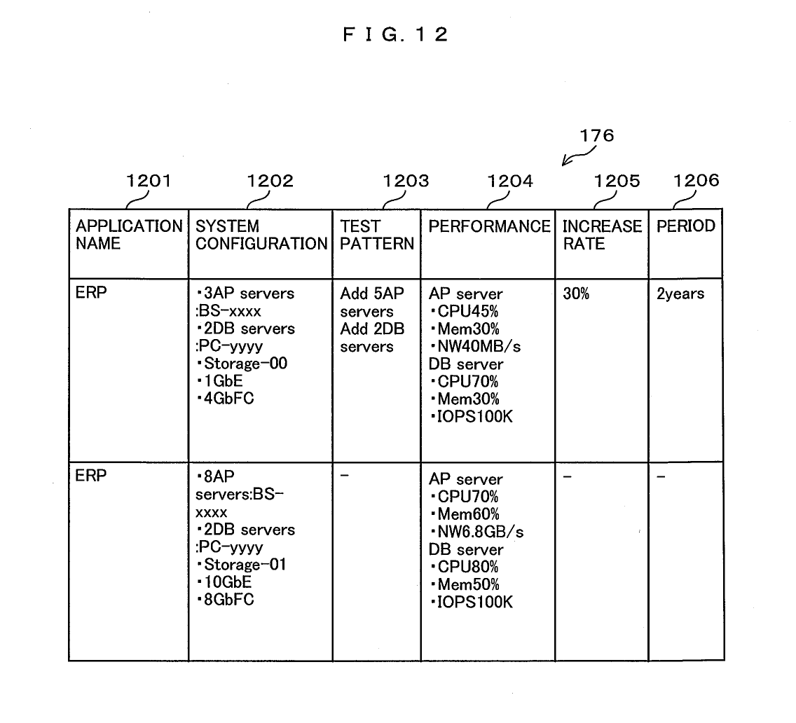

FIG. 12 shows an example of a case list 176 of past sizing tests performed by the DC 10. From past cases in the case list 176, the user can learn what value of performance 1203 in what system configuration 1202 can be expected in installation before application, for example, ERP registered in a field of an application name 1201 is installed and how long (a period 1206) and at what increase rate 1205 the user who executes the ERP in the system configuration 1202 has expanded the system in this system configuration 1202.

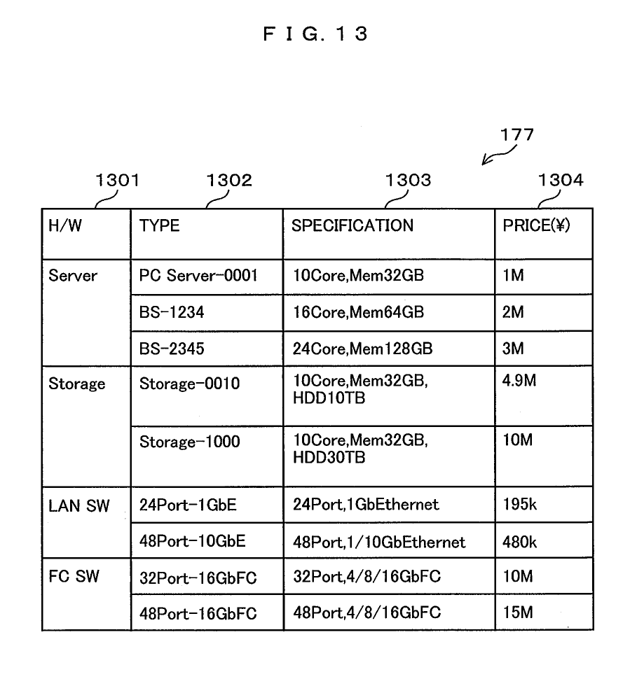

FIG. 13 shows an example of a H/W cost list 177. The H/W cost list includes H/W 1301 showing a type of hardware, a type 1302, a specification 1303, a price 1304 and others, and is used in calculating a system configuration in consideration of a price when a user inputs the upper limit 607 of the budget for the system which is one of the input parameters in the request table 171 and others for example.

FIG. 14A shows an example of input parameters to a template of a script used when a test is automatically performed. For example, when the VM or the VMs operated in the user site 20 is/are packaged as a virtual disk image, in a field of a VM storage location 1402, a location of a volume in which the virtual disk image is stored, in a field of generated VM 1403, a name of the VM is stored, in a field of a memory 1404, allocated memory size is stored, in a field of a logical CPU 1405, the number of cores allocated to the logical CPU is stored, in a field of NW setting 1406, an allocated NW address (an IP address, a default gateway address, a DNS address and others) is stored, and in a field of H/W ID 1407, a machine name and others of the server 12 that operates the VM are stored respectively as input parameters. Test environment is composed by entering these input parameters 1402 to 1407 in the script template shown in FIG. 14B based upon information included in the sizing request and the DC resource management table 172 and executing the script.

For example, “$1402” in “Path $1402/Al.vhdx” shown in FIG. 14B shows quotation from the VM storage location 1402 and a script for setting a path such as “Path/req/Acorp/Al.vhdx”is generated by incorporating “/req/Acorp/”. Further, “$1406” in “IPAddress $1406” shows quotation from the NW setting 1406 and a script for setting an IP address such as “IPAddress 10.20.30.1” is generated by incorporating “10.20.30.1”.

When information packaged as a virtual disk image includes only data or when the scale of a system to be evaluated is large and only a part is packaged, a script template that the corresponding application held in the DC 10 is selected from the service list 175 based upon the application name 603 included in the sizing request after the VM is activated and the connection to the network is completed and is installed in the activated VM is generated.

When information packaged as a virtual disk image is information of the whole system, a script template that system backup and system cloning are performed is generated.

As the script template is different depending upon contents included in the virtual disk image, input parameters are different depending upon the virtual disk image transmitted from the user. The virtual disk image may also be regenerated by enclosing a booted image file including an installer and executing the booted image file for example.

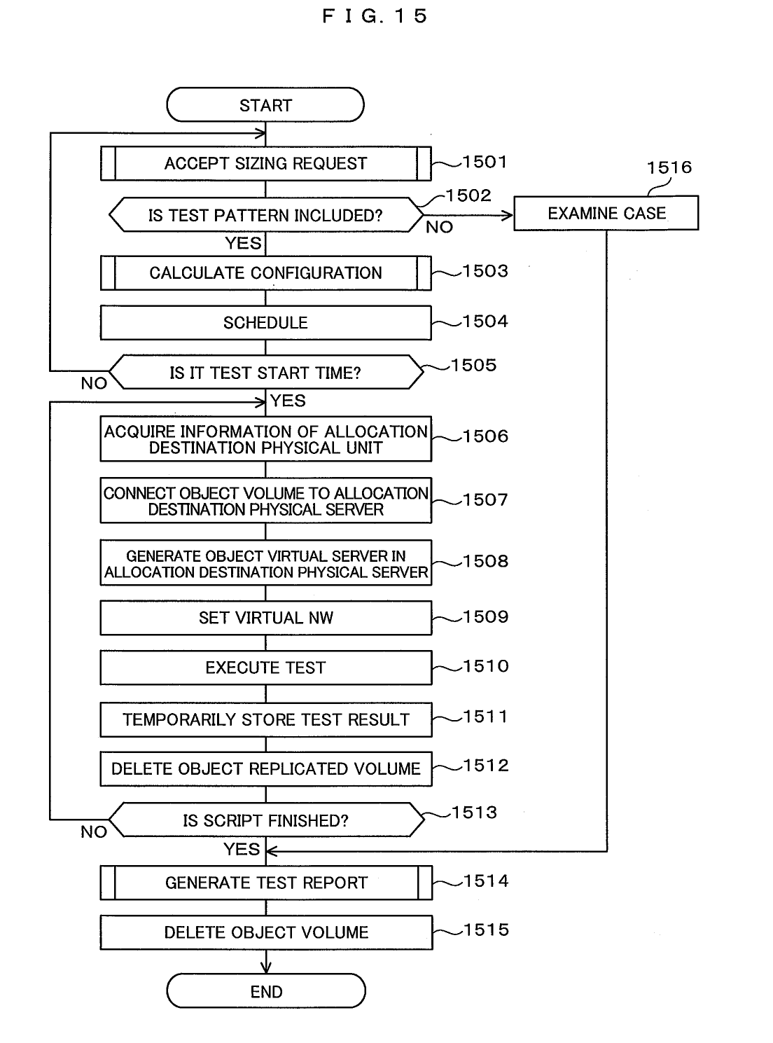

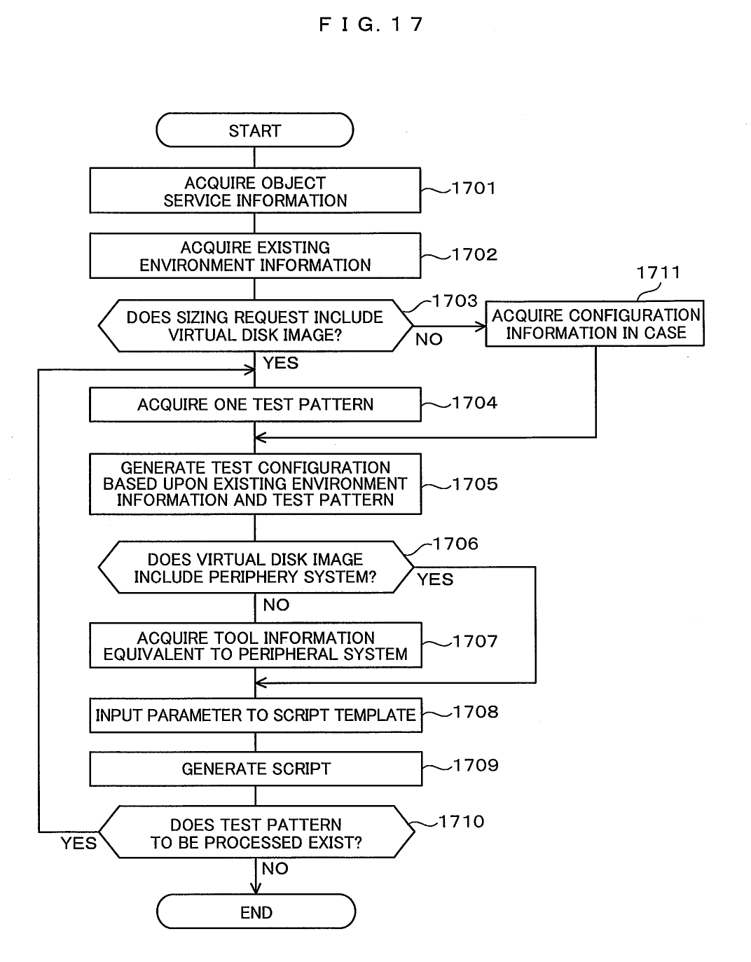

FIG. 15 shows a flow of a process by the sizing server 11 in this embodiment. When the sizing server 11 accepts a sizing request from the client 21 in step 1501, it checks whether a test pattern is included in the received sizing request or not (step 1502). When the test pattern is included, a test configuration described later using FIG. 17 is calculated based upon the test pattern in step 1503 and when no test pattern is included, a test pattern of the application 603 included in the sizing request is acquired based upon the case list 176 in step 1516. When no virtual disk image is included in the sizing request, the test is not required to be performed by acquiring a case equivalent to the application 603 included in the sizing request from the case list 176 and responding to the client 21 in relation to the case and the process is finished.

To compose test environment in the test execution environment 16 in the DC 10 using the test configuration calculated in step 1503, an available time zone of resources in the test execution environment 16 is scheduled based upon the request table 171, the DC resource management table 172, the DC schedule table 173, the test pattern table 174 and the service list 175 in step 1504. For example, as existing active environment is included in a virtual disk image when a user “A Corp” requests a test under the existing active environment including two AP servers and two DB servers in a case that two AP servers are increased in a test pattern #1:1 and in a case that two DB servers are increased in a test pattern #1:2, it is scheduled that the test pattern #1:1 will be performed at 13:50 on Jun. 21, 2013 (13/06/21) using Host#02, Host#03, Host#05 and Host#06 and the test pattern #1:2 will be performed at 0:30 on Jun. 22, 2013 (13/06/22) using the same Host#02, Host#03, Host#05 and Host#06 after the test pattern #1:1 is finished.

In step 1505, the environmental composition of the test is started at test start time according to the DC schedule table 173. Steps 1506 to 1512 are processed by the execution of the object script 803. In step 1506, the location information of a volume that stores the test environment placement destination server 12 allocated in step 1504 and a virtual disk image is acquired. In this case, when plural test patterns for the object volume exist and the current execution of this script is not the last test for the corresponding volume, the replication of the object volume is generated and the location information of the generated replication is passed to step 1507.

In step 1507, the object volume acquired in step 1506 is mounted in the allocated server. In step 1508, the VM 217 is generated in the allocated server 12 and in step 1509, virtual NW allocated to the generated VM 217 is set. Further, log information extracted by the application log manager 501 is set so that the operation of the application can be reproduced based upon the log information in the VM. In this case, as setting for the number of the servers is entered in a script when the information of plural servers is included in a virtual disk image for example, step 1508 and step 1509 are repeated according to the script.

In step 1510, the application is executed, in step 1511, the activity ratio of a CPU in the VM that executes the application, the activity ratio of the memory, a network bandwidth, delay time since one transaction is input to the application until the transaction is output and others are acquired at a fixed interval according to time elapse, a result of the executed test is temporarily stored, and its storage location is stored. At this time, in the request table 171, the test result 611, the request number 602, the user ID 601 and the test pattern 610 are linked. In the test execution of the application, when a load test tool for example is included in a virtual disk image, the corresponding load test tool has only to be executed and a benchmark tool held in the DC 10 and others may also be utilized. When no log information is extracted by the application log manager 501, the load test tool, the benchmark tool and others can be utilized and even if log information is extracted, the load test tool, the benchmark tool and others can be utilized when operation different from the log information is required.

In step 1512, when the mounted volume is a replication, the object replication volume is deleted. When the execution of the script 803 is finished (step 1513), a test report is generated in step 1514, and when all tests for the object volume are finished, the object volume is deleted (step 1515).

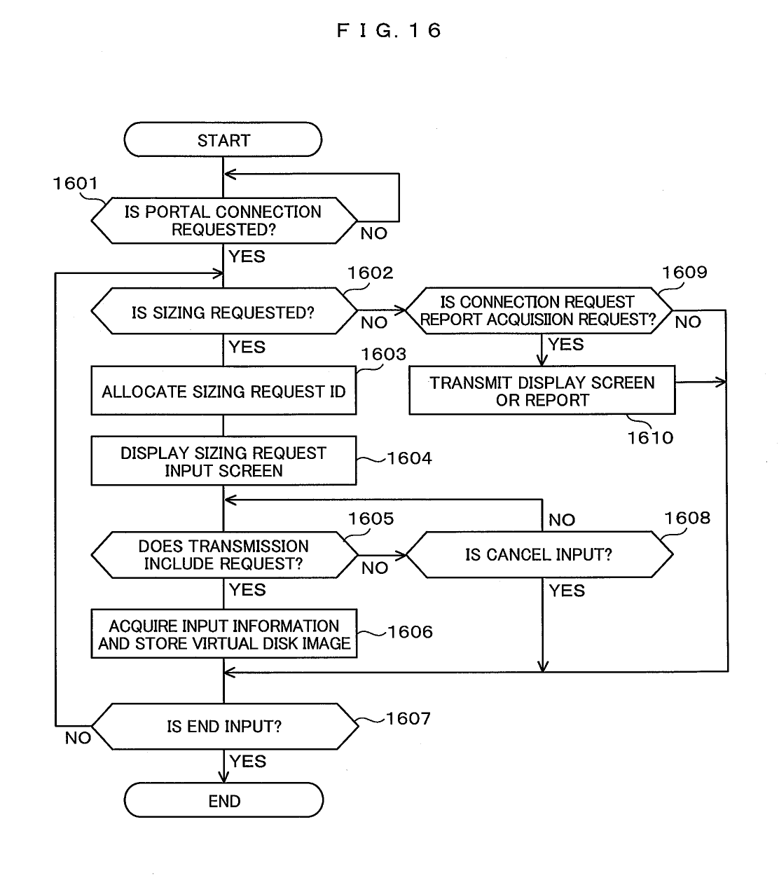

FIG. 16 shows an example of a flow of the sizing request acceptance process in step 1501. In this case, an example when an interface between the sizing server 11 and the user is according to a Web format is shown. When a request for connection from the client 21 to the sizing portal 120 is received in step 1601, an identifier of the sizing request, that is, the request number 602 is allocated in a case that the corresponding connection request is a sizing request (step 1602) and a sizing request input screen is transmitted to the client 21 (steps 1603, 1604). When request transmission notice is received from the client 21 (step 1605), input information, a virtual disk image and log information respectively included in the request transmission notice are acquired, the input information is stored in the request table 171, and when the virtual disk image and the log information exist, the volume including the virtual disk image and the log information are stored in the storage 13 (step 1606). When cancel is input, processing is returned to step 1605.

When the connection request from the client 21 is a report acquisition request (step 1609), an object report is acquired from the report list 178 based upon the request number 602 included in the report acquisition request and a display screen is transmitted to the client 21 or a report is transmitted to the client using a file transfer protocol (FTP), a mail and others (step 1610). Until END is input, the processing is returned to step 1602 to check whether another sizing request is made or not.

FIG. 17 shows an example of a flow of a process for calculating test configuration by the configuration calculation engine 130 (step 1503). The information 603 of an application which is an object of the test is acquired based upon the request table 171 in step 1701 and the existing environment information 608, 612, 613 of a user that operates the application is acquired in step 1702. When a sizing request includes a virtual disk image (step 1703), one test pattern 903 which is an object of execution is acquired from the DC schedule table 173 (step 1704). A test configuration is generated based upon the existing environment information acquired in step 1702 and the test pattern 903 (step 1705).

For example, a user “A Corp” requests a test when two AP servers are increased in existing active environment in which two AP servers and two DB servers are included and a test pattern is “#1:1” and Host#02, Host#03, Host#05 and Host#06 are used for the server 12 for executing the test based upon the DC schedule table 173. The test configuration (topology) is determined based upon each server 12 for executing the test, an NW interface address and a HBA address with which each server is respectively provided and an allocation destination path of a volume including a disk image. When no peripheral system (for example, an application which shares DB with a test object application) is included in the virtual disk image except the test object application, a tool equivalent to the corresponding peripheral system is acquired from the service list 175 which the DC 10 holds (step 1707).

Information generated and acquired in steps 1705 to 1707 is input to a script template as input parameters (step 1708) and the script is generated (step 1709). When a test pattern to be processed exists at time when this process is called (step 1710), a series of processing from step 1704 to step 1709 is executed. When no virtual disk image is included in the sizing request in step 1703 and user data is included in a received volume, a test object application is acquired from the service list 175, a system configuration in an application execution case of the test object is acquired from the case list 176, and the system configuration is input to a script pattern. When no user data is also included in the received volume, the application execution case of the test object is acquired from the case list 176 and processing for generating a report to the user is executed.

To manage the virtual disk image and allocate a virtual disk used by VM in calculating the configuration, the virtual disk management table managed by the server manager 163 can be utilized. FIG. 20 shows an example of the virtual disk management table. The virtual disk management table holds the H/W ID 701 of the server 12 in which the VM 217 is arranged, the VM ID 612, virtual disk ID 2001, a path 2002 showing a location in directory structure of the virtual disk in a file system, a logical volume (LU) 2003 which is a destination of storage when a volume in a disk drive is further divided into one or more logical volumes or partitions and the file system is configured, a connecting location (an allocation destination) 2004 in the server of the disk drive which is a destination of storage, a device number 2005 allocated to the disk drive and a name 2006 of a port in a connected network interface.

In this case, the connecting location 2004 of the disk drive is represented in the combination of the OS or LUN determined by the virtualizing program and identification numbers of a target and the SCSI bus according to the SCSI standard. The unique device number 2005 is allocated to the disk drive using a device identifier which the server can acquire from the storage device for example by the OS or the virtualizing program. A port name (WWN) used for connecting to the SAN 15 that connects the server 12 and the storage 13 is held in a field of the connection destination port name 2006 and when multiple passes or a link aggregation are/is installed, plural port names may also be in the field 2006 or the field is divided into plural records and the plural port names may also be held there. The configuration information of these can be all acquired from the OS in the server or the virtualizing program so that access to the virtual disk is enabled in the execution of the test.

Further, when hardware in user's existing environment included in a sizing request is old, performance in its specifications is lower than performance in those of hardware in the test execution environment 16 and the user's existing environment cannot be reproduced, simulation is enabled by comparing the type of the hardware in the test execution environment 16, for example, the server 12 with the type of the server 22 in the user environment, logically dividing the CPU core 101 and the memory 100 and approximating the specifications of the test execution environment to those of the hardware in the user's existing environment.

Since the performance and others of the server 12 in the test execution environment 16 are adjusted as described above and the configuration is calculated, server performance information managed by the server manager 163 can be utilized. FIG. 21 shows an example of the server performance information. In a field of the server performance information, for example, the number of CPU cores 2102, memory capacity 2103, a NW bandwidth 2104, a disk I/O bandwidth 2105 and a port name list 2106 of the FC respectively corresponding to the H/W ID 701 for identifying the server are stored together with time 2102 at which information is acquired by the server manager 163. In the server performance information, another parameter which can be acquired by the server manager 163 may also be held if necessary.

In the performance information of the VM, for example, the number of logical CPU cores 613 allocated corresponding to the VM ID 612 for identifying the VM in the server, average activity ratio 2108 of a logical CPU, the memory capacity 613, an NW bandwidth 2109, an NW average transmission rate 2110, a disk I/O bandwidth 2111, disk average I/O volume 2112 and disk activity ratio 2113 are held together with a status of the VM (for example, normally active or halt) 2107. In the performance information of the VM, if necessary, another parameter which can be acquired by the server manager 163 may also be held.

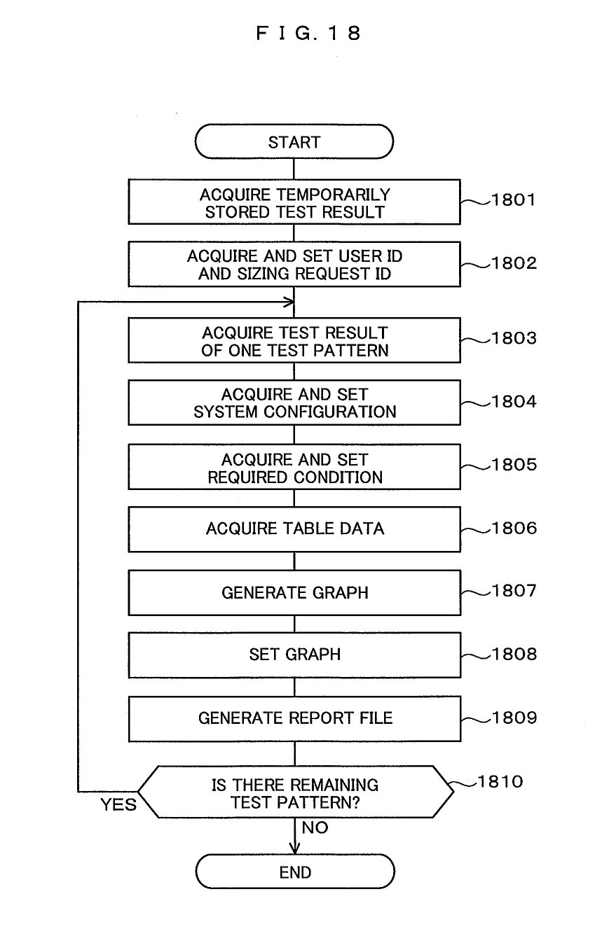

FIG. 18 shows an example of a flow of the report generation process in step 1514. The test result 611 temporarily stored in step 1511 is acquired. The test result is formatted into a report document and a Web file by inputting parameters of each data such as the user ID, the system configuration every test pattern, the required condition and the test results (for example, the CPU load maximum value, the CPU load average value, the maximum latency and the average latency respectively represented by digits or respectively acquired by graphing plural data when the plural data are included in an expression) in a report format specified for a document or in Web XML.

In step 1802, the user ID 601 and the request number 602 are acquired based upon the test result the report of which is acquired and are set as an identifier of one report. A result for one pattern which is the temporary test result information 611 acquired in step 1801 is extracted (step 1803). The system configuration is acquired from the acquired temporary test result information, is set in the report format or the XML format (step 1804), and the required condition is similarly acquired and set (step 1805). In step 1806, when the temporary test result information includes table data, for example, a CPU load and memory activity ratio in certain elapse of time, a graph is generated based upon the table data in step 1807, in step 1808, the generated graph is set in the report format or the XML format, and the graph is recorded as a report file in step 1809. When the test pattern 610 still remains unprocessed in the request number 602 (step 1810), a series of processing from step 1803 to step 1809 is executed.

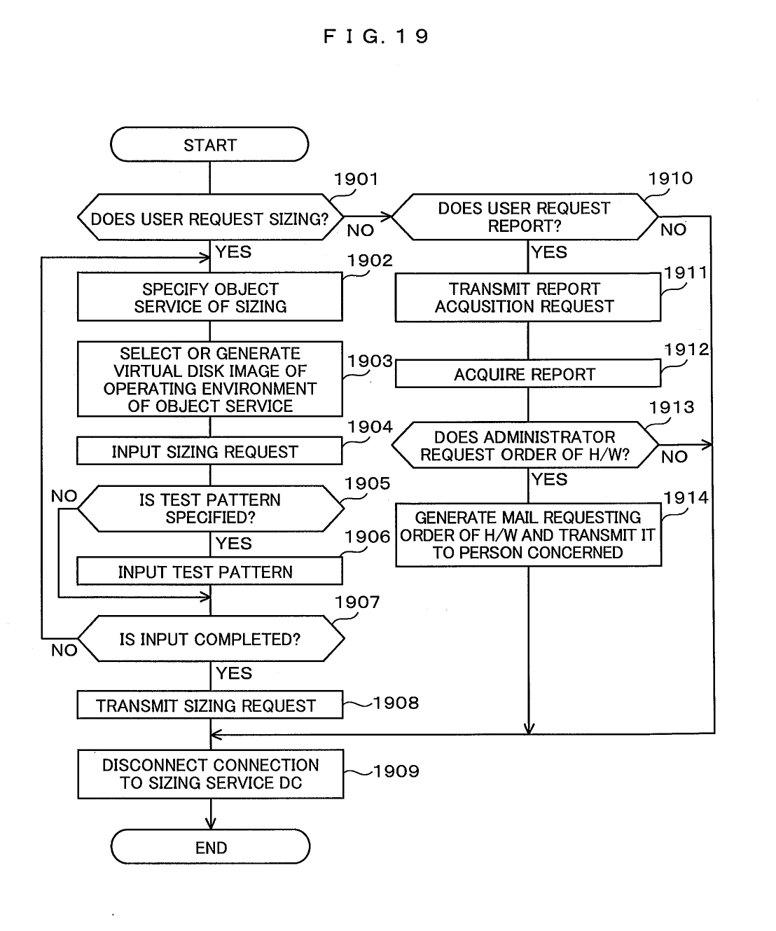

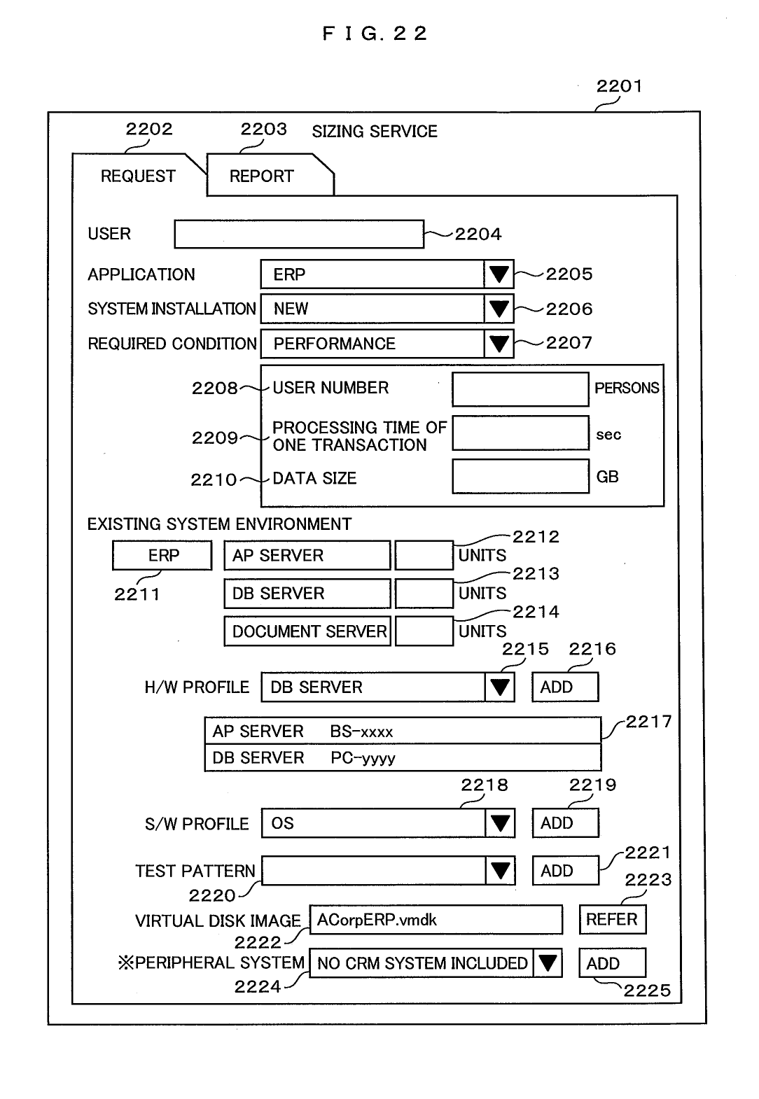

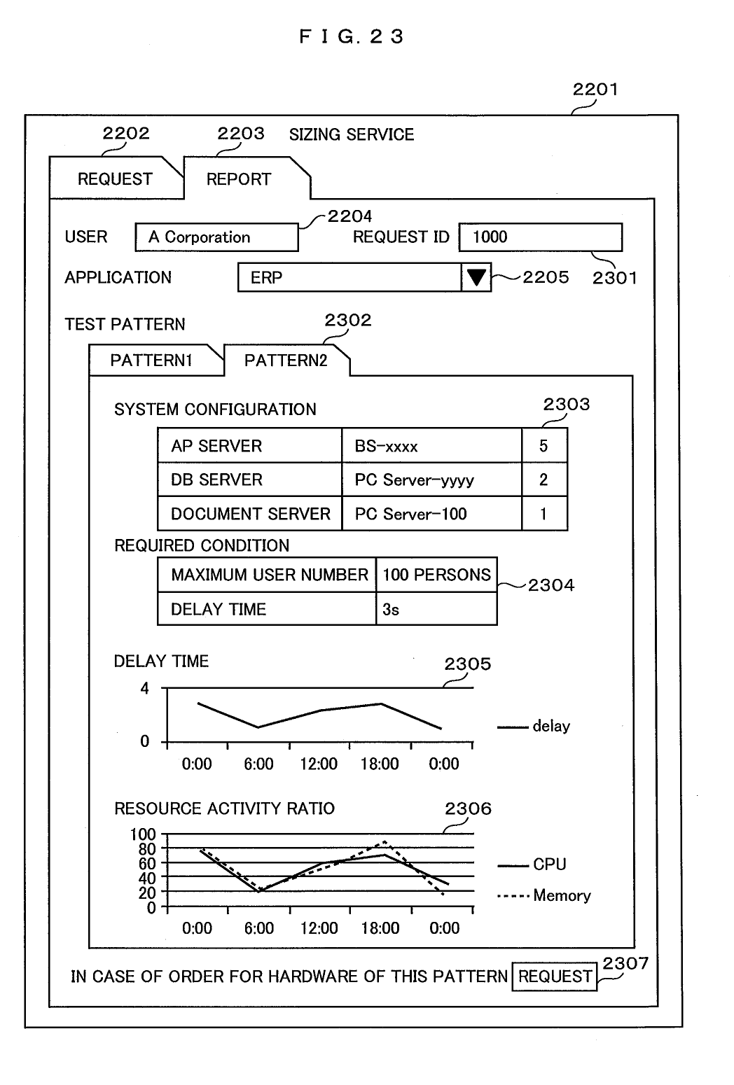

FIG. 19 shows an example of a flow of a process by the client 21. The user makes a sizing request by inputting parameters according to an example of a client screen shown in FIG. 22. When operation by the user is a sizing request (step 1901), an application which is a sizing object is specified (step 1902), a virtual disk image showing the current active environment of the object application is selected, and a package including required data, an OS, the application and others is generated (step 1903). For example, since no corresponding application exists though only data exists in the case of a newly installed application, data is selected and generated, and for example, when system backup data including the application based upon the data exists, system backup data is selected and generated.

Request data is input according to input parameters on the other client screen (step 1904). When a test pattern exists (step 1905), the test pattern is specified (step 1906). When data input is completed (step 1907), a volume including the sizing request and the selected or generated virtual disk image is transmitted to the sizing server 11 (step 1908), connection with the sizing server 11 is disconnected (step 1909).

When operation by the user is a report request (step 1910), a report acquisition request including the user identifier 601 and the sizing request identifier 602 is transmitted to the sizing server 11 according to an example of a client screen shown in FIG. 23 (step 1911). A response to the report acquisition request from the sizing server 11 is received, a report is acquired, and the report is displayed on the screen (step 1912). In this case, when the user examines the purchase of hardware used for the configuration of a certain test pattern, for example, the server as a result of the test pattern and requests the person concerned to order the hardware related to the system configuration (step 1913), means for communicating with the person in charge of a request related to processing for ordering including the information of the corresponding hardware (for example, an estimate acquisition request and others), for example, means for creating and transmitting a mail may also be provided (step 1914).

FIG. 22 shows an example of a sizing request input screen in sizing service for displaying for the client 21. A screen 2201 is a sizing service input screen displayed in connecting to the sizing server 11 or in activating a corresponding application when the sizing service is the application. Tab 2202, 2203 are provided to display the input screens for a sizing request and for a report acquisition request. An input field 2204 is a field for inputting an identifier of the user and for example, a corporation name, an organization name and others are input. An input field 2205 is a field for inputting an application which is a sizing object and general business applications may also be selected from a pull-down menu.

An input field 2206 is a field for inputting whether this sizing request is for installing a new application or not, whether this sizing request is for the expansion of a scale or not or whether this sizing request is for the addition of an application or not and the like, and input may also be selected from a pull-down menu. An input field 2207 is a field for inputting information to be acquired by sizing and a required condition and for example, when the required condition is performance, the supposed number of users 2208, allowable delay time 2209 of time for processing one transaction, data size 2210 used by the application and others are input. Input fields 2211 to 2219 are fields for inputting in relation to existing system environment currently made active by the user. In the input fields 2211 to 2214, a general configuration is automatically displayed by the application input in the input field 2205. For example, in the case of an ERP system, an AP server, a DB server, a document server and others are displayed.

In each input field 2212 to 2214, the number of respective servers is input. Each input field 2215 to 2217 shows a field for inputting profile information of the hardware input in the input fields 2212 to 2214. The input field 2215 is a field for inputting a type of the hardware and a general configuration may also be selected from a pull-down menu by the application input in the input field 2205. The information input in the input field 2215 or selected is displayed in the display field 2217 by pressing the ADD button 2216. The input field 2218 shows a field for inputting software profile information. The input field 2218 is a field for inputting software, for example, an OS, a virtualizing program and others and they may also be selected from a pull-down menu. Input or selected information may also be listed as shown in the display field 2217 by pressing the ADD button 2219.

An input field 2220 shows a field for inputting a test pattern. In the input field 2220, a test pattern for sizing such as sizing information when two AP servers are added is required to be acquired, the ERP system having a necessary system configuration at the minimum is composed at a fixed budget and an application is added in existing environment is input. Selection from a pull-down menu and text input are also possible. When text input is allowed, the sizing server 11 may also be provided with means for analyzing acquired text data in a step for acquiring a test pattern and for comparing and matching the text data with fixed data. The input in the input field 2220 can be settled by pressing an ADD button 2221. An input field 2222 is a field for selecting a virtual disk image including existing environment of the application of the sizing object and a file of an object displayed in a link with a function for displaying a list of files stored in a file system by pressing a REFER button 2223 can be selected.

An input field 2224 is an input field for notifying whether or not the virtual disk image selected in the input field 2222 includes not only the application of the sizing object but a peripheral related system. For example, when the performance of the whole system is evaluated, volume size is enormous in the whole system and possibility that transmission is impossible occurs. In this case, when a sizing request that no peripheral related system is included is made, the sizing server 11 selects an application and a benchmark tool respectively held in the DC 10 for a CRM application and can simulate the behavior of the peripheral related system. Input in an input field 2224 can be settled by pressing an ADD button 2225.

FIG. 23 shows an example of a report screen displayed when a response by the sizing server 11 to a report acquisition request is received. A screen 2201 to an input field 2205 are the same as those in FIG. 22. A display field 2301 is a field showing a request number showing this report is related to what sizing request. The request number is an identifier responded by the sizing server 11 when the sizing request is transmitted. A tab 2302 is a tab for displaying a report every test pattern when the sizing request includes plural test patterns. A display field 2303 shows a system configuration used in the corresponding test pattern, a display field 2304 shows a required condition in the corresponding test pattern, and display fields 2305, 2306 show an example of graphed results in which the corresponding test pattern is executed. The display fields 2305, 2306 may not be displayed in a graph format but may be displayed in a table format. When the user that examines this report examines the purchase of hardware used in the configuration of the corresponding test pattern, means (for example, a mail to a person in charge of order) for notifying that related processing is requested of the person in charge of order for example and others is activated by pressing a REQUEST button 2307.

FIG. 24 shows an example of log information in which the operation of the application is recorded. The log information includes time 2401 at which the log is taken, session ID 2402 of communication in access from the user to the system or the application, a transmitter address 2403 and a port number 2404 of the transmitter respectively of the user, a destination address 2405 and a destination port number 2406 respectively used in the operation of the system or the application, a sequence number 2407 of communication and data 2408 which are contents of the access. A status of a period in which log information is taken can be reproduced by the application log manager 501 by reproducing access from the user via Ethernet using the information of the session ID 2402 to the sequence number 2407 and accessing in contents corresponding to each time of the data 2408 at each time in the time field 2401 for example. The log information is not limited to these information and if only the log information is information upon which the status can be reproduced, the information may also be any information. For example, the data of the storage read during the operation of the application may also be included.

As described above, as the test can be executed in the sizing service DC with the execution environment of the user site copied as it is, a high-precision test close to the actual environment of the user site can be executed. Further, as the test can be performed in the sizing service DC, resources in the user site are not required to be used for the test.

### REFERENCE SIGNS LIST

10 . . . sizing service DC
11 . . . sizing server
16 . . . test execution environment
130 . . . configuration calculation engine
150 . . . test environment composer
160 . . . resource manager
20 . . . user site
21 . . . sizing client
26 . . . user execution environment
501 . . . application log manager

1. A computer system connected to a client, the system comprising:
the client having a system configuration including a first storage that stores data and a first computer;
the computer system having a second storage that stores data, a second computer that processes data stored in the second storage and a management server;
wherein the management server acquires an identifier of an application processed in the first computer, data utilized for executing the application and stored in the first storage, and information of the system configuration of the client from the client,
composes the system configuration in the second storage and the second computer based upon the acquired information of the system configuration,
operates the application specified by the identifier in the composed system configuration using the acquired data, and
outputs a result of the operation to the client.

2. The computer system according to claim 1,
wherein at least a second storage has the same configuration as the configuration of the first storage;
at least a second computer has the same configuration as the configuration of the first computer; and
the composition of the system configuration is performed using the second storage and the second computer respectively having the same configurations as the configurations of the first storage and the first computer.

3. The computer system according to claim 1,
wherein the system configurations composed in the second storage and the second computer include information of the system configuration of the client acquired from the client and configuration information of a computer system for a test in which the application is executed; and
the system configuration is a configuration based upon the information of the system configuration and the configuration information related to the computer system for a test.

4. The computer system according to claim 1,
wherein the first computer executes the application in a virtual server; and
the data is a virtual disk image related to the virtual server.

5. The computer system according to claim 1,
wherein the information of the system configuration at least includes the number of CPU cores, memory size, the number of network ports, a network bandwidth which one of the first computers has, and the number of the first computers.

6. The computer system according to claim 5,
wherein the first computer executes the application in the virtual server;
the data is a virtual disk image related to the virtual server;
the management server stores the acquired virtual disk image in the second storage,
sets a network that connects a storage area in which the virtual disk image is stored and the second computer in which the virtual server is arranged, and
composes the system configuration by generating the virtual server based upon the information of the system configuration and the virtual disk image.

7. The computer system according to claim 4,
wherein a result of the operation at least includes the activity ratio of a CPU, the activity ratio of the memory, a network bandwidth and delay time in the virtual server which executes the application for one transaction from inputting to outputting.

8. The computer system according to claim 1,
wherein it is checked whether an identifier of another application and data for another application are included in data acquired from the client, utilized for executing the application specified by the identifier and stored in the first storage or not; and
when another application and the data for another application are included, the system configuration is composed by adding a configuration where another application is executed to the system configuration where the application specified by the identifier is executed.

9. The computer system according to claim 1,
wherein it is checked whether an identifier of another application and data for another application are included in data acquired from the client, utilized for executing the application specified by the identifier and stored in the first storage or not;
when only data for another application is included, the system configuration is composed by adding a configuration in which another application is executed to the system configuration in which the application specified by the identifier is executed; and
another application or a benchmark tool similar to the execution of another application out of plural applications and plural benchmark tools respectively which the management server held and managed is executed.

10. The computer system according to claim 4,
wherein the client at least has an application identifier of that specifies the application, an installation status including one of new installation and additional installation of the application, the number of maximum users simultaneously processed in the system configuration in which the application is executed, information of a required condition including one transaction processed time or data size, information of hardware specifications of the first computer and the first storage, and the virtual disk image.

11. A processing method in a computer system of connecting to a client having a system configuration including a first storage that stores data and a first computer and having a second storage that stores data, a second computer that processes data stored in the second storage, and a management server, the method comprising:
the management server acquires from the client an identifier of an application processed in the first computer, data utilized for executing the application and stored in the first storage, and information of the system configuration of the client;
the system configuration is composed in the second storage and the second computer based upon the acquired information of the system configuration;
the application specified by the identifier is operated using the acquired data in the composed system configuration; and
a result of the operation is output to the client.
